(19) United States
(12) Patent Application Publication
(10) Pub. No.: US 2011/0126655 A1
(43) Pub. Date: Jun. 2, 2011

(54) TRANSMISSION OIL CONTROL AND METHOD FOR LUBRICATING TRANSMISSION GEARS

(75) Inventor: Eckhard KIRCHNER, Ginsheim (DE)

(73) Assignee: GM GLOBAL TECHNOLOGY OPERATIONS, INC., Detroit, MI (US)

(21) Appl. No.: 12/914,795

(22) Filed: Oct. 28, 2010

(30) Foreign Application Priority Data
Oct. 31, 2009 (DE) 102009051532.1

(51) Int. Cl. F16H 59/04; F16H 57/04

(52) U.S. Cl. 74/467; 74/473.36; 74/473.3

(57) ABSTRACT

A transmission oil control is provided for a motor vehicle transmission comprises at least one oil line adapted to lubricate a transmission gear assigned to the oil line. The oil line can be opened and/or at least throttled by means of a throttle element. A gearshift element is provided for a gear shift device. The engaged transmission gear can be represented through the gearshift element. The throttle element is connected to the gearshift element in such a manner that for the engaged transmission gear, the associated oil line can be opened and/or that the oil line can at least be throttled for another engaged transmission gear. Since the lubricating oil flow for the transmission gears which are not engaged can be automatically reduced, the total lubricating oil flow can be reduced.

### CROSS-REFERENCE TO RELATED APPLICATION

This application claims priority to German Patent Application No. 102009051532.1, filed Oct. 31, 2009, which is incorporated herein by reference in its entirety.

### TECHNICAL FIELD

The technical field relates to a transmission oil control for a motor vehicle transmission and a method for lubricating transmission gears of a motor vehicle transmission, by means of which the individual transmission gears of the motor vehicle can be lubricated.

### BACKGROUND

By means of a motor vehicle transmission, the power output of an internal combustion engine of a motor vehicle can be transmitted and transferred to the drive wheels of a motor vehicle. For this purpose, a motor vehicle transmission is provided with a plurality of transmission gears into which can be shifted, for example, by means of a manual gear shift in order to be able to set a certain transmission ratio between a transmission input shaft and a transmission output shaft. In the individual transmission gears, the power transmission between the transmission input shaft and the transmission output shaft takes place in particular through gearwheel pairs. To reduce the wear of the transmission gears it is known to lubricate the transmission gears. For this purpose, the lubricating oil flow is dimensioned for each transmission gear under consideration of the maximum power to be transmitted by the respective transmission gear.

It is at least one object of the invention to provide a transmission oil control and a method for lubricating transmission gears of a motor vehicle, by means of which the required lubricating oil flow can be reduced. In addition, other objects, desirable features and characteristics will become apparent from the subsequent summary and detailed description, and the appended claims, taken in conjunction with the accompanying drawings and this background.

### SUMMARY

An embodiment of the transmission oil control for a motor vehicle transmission, in particular a manual transmission, provides at least one oil line for lubricating a transmission gear assigned to the oil line. The volume flow through the oil line can be throttled by means of a throttle element. Further, a gearshift element for a gear shifting device is provided. The engaged transmission gear is representable by said gearshift element. The throttle element is connected to the gearshift element. Through the gearshift element and by means of the throttle element, a larger volume flow through the associated oil line can be adjusted or is adjusted for a non-power transferring transmission gear than for a non-power transferring transmission gear. This is done in that in case of a power transferring transmission gear, the volume flow through the associated oil line is not at all or only slightly throttled, whereas, compared thereto, for a power transferring transmission gear, the volume flow is more throttled.

Via the gearshift element, the engaged transmission gear can be read from the throttle element in particular through a mechanically defined position, wherein the throttle element can be actuated in particular through a mechanical connection to the gearshift element. The lubricating oil flow can be adjusted in a purely mechanical manner. Furthermore, churning losses can be reduced whereby the efficiency improves. Through the connection of the gearshift element with the throttling element it is achieved that for the currently engaged and thus power transferring transmission gear, virtually unthrottled and thus large lubricating oil flow is made available so that the associated gearwheel pair is sufficiently lubricated. For transmission gears which are not engaged or not power transferring, the lubricating oil flow is throttled, in particular more throttled than for a power transferring transmission gear, or even completely blocked. As a result, for the power transferring transmission gear, a larger volume flow through the associated oil line can be adjusted or is adjusted than for a non-power transferring transmission gear.

Here, the knowledge is used that substantially only the engaged transmission gear needs to be lubricated since substantially only in the engaged transmission gear, a power transmission takes place. Since through the rest of the transmission gears substantially no power is transmitted, the gearwheels of the non-power transferring transmission gears are substantially load-free and require, if at all, only a smaller amount of lubrication compared to full load. Thereby, the maximally available lubricating oil flow can be reduced without the risk of insufficient lubrication for the currently engaged transmission gear. For a sufficient lubrication of the of the transmission gears, thus, a lower pump capacity is required so that the efficiency of the motor vehicle transmission lubricated is improved. This results in a reduction of fuel consumption and a reduction of CO2 emission. Opening and throttling the respective oil line can take place in particular without an electronic circuit. In particular, a mechanical connection of the gearshift element with the throttle element is provided so that in particular in case of gear shift transmissions, with the force exerted during actuating the gearshift lever, at the same time, corresponding oil lines can be automatically opened and/or at least throttled.

Preferably, the oil line has a flexible hose. The hose can be pressed together by the throttle element to reduce the flow cross-section. Thus, the oil line can be squeezed together by the throttle element at least partially in the area of the flexible hose so that the flow cross-section is automatically reduced. In particular, if, at the same time, in another oil line the flow cross-section is enlarged to the same extent, the total lubricating oil flow can remain constant. Depending on the engaged transmission gear, the distribution is simply adapted automatically to the individual transmission gears. For example, the throttle element can be configured as simple throttle shoe which, through its substantially linear movement, presses the flexible hose together in particular against a stopper opposite to the throttle shoe. This can be achieved with little force so that the shifting comfort for a manual transmission is not affected. It is in particular possible to avoid complicated throttling valves. Furthermore, a constructionally simple connection between the gearshift element and the throttle element can be provided which can be implemented in an installation space-saving manner.

Particularly preferred, the throttle element is spring loaded. With the transmission gear of the assigned oil line engaged, the spring load is lower than with the transmission gear of the assigned oil line not engaged. This results in that, in case of a manual transmission, at the beginning of the shifting, the driver can feel a resistance through the spring-loaded throttle element which resistance decreases during engagement of the gear. The driver thereby receives a haptically noticeable feedback via the engagement of the desired gear. This increases the shifting comfort and supports an optimal and correct position of the gearshift lever.

Preferably, for opening or/and throttling the oil line, the throttle element is kinematically guided by the gearshift element via a slotted guide and/or a locking contour. Through the slotted guide, which can in particular correspond to the gearshift lever slotted guide for the gearshift, a precisely defined movement of the throttle element during shifting the motor vehicle transmission can be specified. In particular, it can be planned in advance in which position the throttle element is at a certain engaged transmission gear. Based on this position of the throttle element or the corresponding gearshift element, mechanical shifting means can be provided which initiate the opening and/or throttling of the oil line. Additionally or alternatively, in particular an axial movement can be applied via the locking contour through the gearshift element onto the throttle element. For example, the throttle element can be moved over a surface of the locking contour, which, in a position of the gearshift element corresponding to an engaged transmission gear of the oil line assigned to the throttle element, for example, has a projection so that the throttle element is automatically moved in axial direction towards the oil line in order to throttle the oil line, in particular by compressing a flexible hose.

In particular, the throttle element is connected to the gearshift element in a purely mechanical manner. An electrical control as well as sensors and actuators to open and/or close the oil line depending on measuring data are not necessary. The oil lines for lubricating the transmission gears can in particular run in the area of a gearshift rod so that the gearshift element, for example, can be connected to the gearshift rod to actuate in spatial vicinity to the oil lines one or more throttle elements. The gearshift element can in particular be rigidly connected to the gearshift rod so that through a rotation and/or the axial displacement of the gearshift rod, the respectively engaged transmission gear can be mechanically represented by the gearshift element via the respective positioning of the gearshift element.

Preferably, the gearshift element is part of a locking cylinder for limiting a shifting movement of a gearshift rod and/or part of a guiding cylinder. By means of the locking cylinder or guiding cylinder can be avoided that during a change of two adjacent shift gates, the gearshift lever is moved diagonally by mistake, or a gear is engaged which is not intended. When configuring the locking cylinder or guiding cylinder, the gearshift element can be formed, for example, as protruding finger. Thus, it is not required to provide an additional component but to use an already existing component in the form of the locking cylinder or guiding cylinder to create the gearshift element. Furthermore, it is possible to provide the locking cylinder at almost any position in axial direction of the gearshift rod so that the locking cylinder can be positioned in particular in spatial vicinity to the oil lines.

In a preferred embodiment, the gearshift element is configured as protruding gearshift pin, wherein the throttle element is configured in such a manner that for opening the oil line, the gearshift pin engages with a receiving pocket of the throttle element. Alternatively, the throttle element can comprise a protruding gearshift pin which, for opening and/or closing the oil line engages with a receiving pocket of the gearshift element. The gearshift pin and the receiving pocket are dimensioned in particular in such a manner that in neutral position, the gearshift pin is positioned outside of the receiving pocket. When shifting a certain transmission gear out of the neutral position, the gearshift pin can engage with the receiving pocket and exert a force on the gearshift element, and on the base of said force, the oil line can be opened. During shifting in a further transmission gear, the gearshift pin can first move the receiving pocket backwards, thereby, for example, tensioning a spring before the gearshift pin engages with a another receiving pocket of a throttling element for another transmission gear. During shifting of transmission gears, the respective oil lines can be automatically opened and/or at least throttled through a solution that can be implemented in a mechanically simple manner.

Preferably, the receiving pocket can be moved substantially along a circular path. The circular path is arranged in particular coaxially to the moving direction of the gearshift pin during engaging a transmission gear out of a neutral position. The receiving pocket can be guided in particular along said circular path, for example through a slotted guide. In particular, in direction towards the neutral position, a stopper is provided for the receiving pocket so that during a movement of the gearshift pin in the direction of the neutral position, the gearshift pin can be moved automatically out of the receiving pocket when the receiving pocket abuts against the stopper and is not moved any further.

A gear shift mechanism is also provided for a motor vehicle, in particular manual transmission, comprising a gearshift rod which is in particular connected to a manually actuatable gearshift lever, wherein the gearshift rod can be moved in axial direction and/or circumferential direction for shifting a transmission gear. The gear shift mechanism comprises further a transmission oil control which can be configured or developed in particular as described above. The transmission oil control is connected to the gearshift rod via the gearshift element. The movement of the gearshift rod can be represented via the gearshift element so that the engaged gear can be illustrated through the gearshift element in particular in a mechanical manner. Through the connection of the gearshift element with the throttle element of the transmission oil control, via a simple mechanical connection, an oil line to an engaged transmission gear can be opened and the other oil lines for the transmission gears which are not engaged can be at least throttled. Thereby, the total lubricating oil flow can be reduced and, at the same time, a sufficient lubricating oil flow can be provided even at full load for the engaged transmission gear. The gear shift mechanism can in particular be configured and developed as described above by means of the transmission oil control.

A method is provided for lubricating transmission gears of a motor vehicle, in particular manual transmissions, in which an oil volume flow to the engaged transmission gear is increased in particular by means of a transmission oil control and is reduced to the transmission gear which is not engaged. The transmission oil control can be configured and developed in particular as described above. In particular for each forward transmission gear, in particular each transmission gear, the oil volume flow to the engaged transmission gear is increased and is reduced to the transmission gear which is not engaged. By the fact that the lubricating oil flow to the transmission gears which are not engaged can be at least reduced, the total lubricating oil flow can be reduced. At the same time, a sufficient lubricating oil flow for the engaged transmission gear is ensured even at full load. The method can be configured or developed in particular as illustrated above by means of the transmission oil control.

### BRIEF DESCRIPTION OF THE DRAWINGS

The present invention will hereinafter be described in conjunction with the following drawing figures, wherein like numerals denote like elements, and:

FIG. 1 shows a schematic perspective illustration of a gear shift mechanism;

FIG. 2 shows a schematic partial view of the gear shift mechanism illustrated in FIG. 1; and

FIG. 3 shows a schematic basic illustration of a transmission oil control for the gear shift mechanism of FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

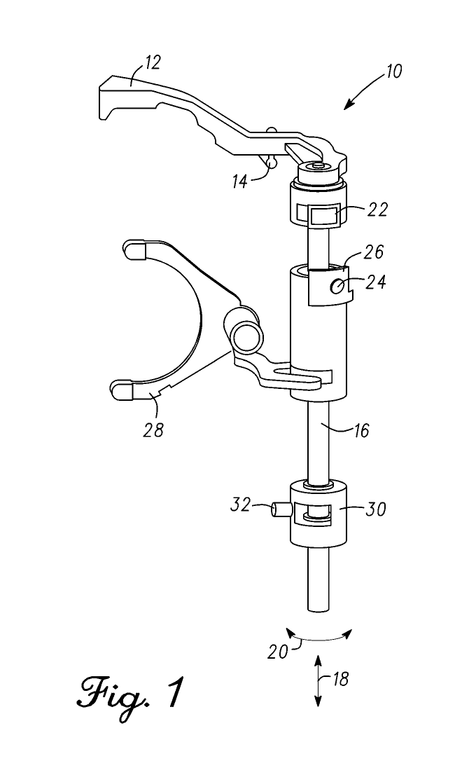

The gear shift mechanism 10 illustrated in FIG. 1 has a gearshift weight 12 which can be connected to a non-illustrated gearshift lever for a manual transmission. The gearshift weight 12 has a connection element 14 for connecting to a gearshift cable. The gearshift weight 12 is further connected with a gearshift rod 16 which can follow the movement of the gearshift weight 12 in an axial direction 18 as well as in a circumferential direction 20. The gearshift weight 12 can further be guided through a guiding groove 22.

The gearshift rod 16 can be guided via a protruding pin 24 in a main contour 26. The main contour 26 comprises in particular a slotted guide through which the movement of a gearshift lever along the shift gate can be specified. By means of the slotted guide of the main contour 26, a simultaneous movement of the gearshift rod 16 in axial direction 18 and circumferential direction 20 can be prevented so that the gear shift mechanism 10 can not get caught. Further, a gearshift fork 28 is connected to the gearshift rod 16, by means of which gearshift fork the movement of the gearshift rod 16 can be transmitted to the interior of the motor vehicle transmission. Also connected to the gearshift rod 16 is a locking cylinder 30 by means of which, for example, the engagement of the reverse gear can be locked. An unintended engaging of the reverse gear can thereby be avoided. In the illustrated exemplary embodiment, the locking cylinder 30 has a gearshift finger 32 by means of which the gearshift fork 28 is moved during shifting. A protruding gearshift pin 31 can actuate the transmission oil control 34 illustrated in FIG. 3 in a kinematically equal manner.

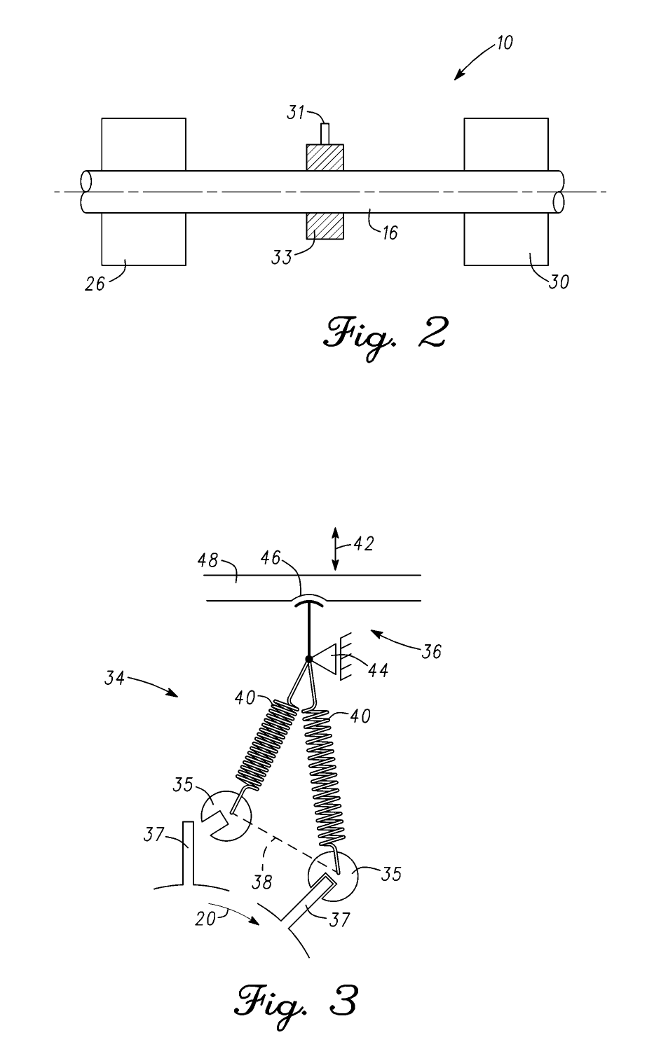

In the embodiment of the gear shift mechanism 10 illustrated in FIG. 2, a support cylinder 33 rigidly connected to the gearshift rod 16 is provided between the main contour 26 and the locking cylinder 30. The support cylinder 33 comprises the gearshift pin 31 to be able to actuate the transmission oil control 34 illustrated in FIG. 3.

For the transmission oil control 34 illustrated in FIG. 3 it is utilized that when engaging a transmission gear, the gearshift rod 16 performs a movement in circumferential direction 20. Thereby, the gearshift pin 31 rigidly connected to the gearshift rod 16 is also moved in circumferential direction out of the neutral position illustrated on the left side into a shifting position illustrated on the right side. During the movement from the neutral position into the shifting position, the gearshift pin 31 can engage with a receiving pocket 35 of a throttle device 36 and move the receiving pocket 35 along a circular path 38. The receiving pocket 35 is connected via a spring 40 to a slide bearing 44 which is movable in a linear direction 42. Connected to the slide bearing 44 is a throttle element 46 which, with a movement in the linear direction 42, can open and/or throttle a flexible part of an oil line 48. In the shifting position, the spring 40 is in particular released and the throttle element 46 configured as throttle shoe is moved away from the oil line 48 so that the flow cross-section of the oil line 48 is at a maximum and a correspondingly large lubricating oil flow to the engaged transmission gear, to which the oil line runs, is provided. For a non-power transferring transmission gear, the spring 40 is compressed and thus pre-loaded so that the throttle element 46 is pressed with the maximum spring force onto the oil line 48. Thereby, the flow cross-section of the oil line 48 is reduced and the lubricating oil supply to the transmission gear which is not engaged is throttled.

In the illustrated exemplary embodiment, for each of the individual forward gears and, if applicable, for the at least one reverse gear, a separate oil line 48 each with one throttle element 46, which is actuated by a gearshift pin 31, is used. Thus, a constructionally identical module can be used for each transmission gear. It is principally possible to provide exactly one gearshift pin 31 for the actuation of one or more throttle elements 46. In particular, all throttle elements 46 for all gears can be actuated by exactly one gearshift pin 32 if the throttle elements 46 are arranged according to the diagram of the respective transmission.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A transmission control for a transmission of a motor vehicle, comprising:
an oil line adapted to lubricate a gear of the transmission assigned to the oil line;
a throttle element with which a volume flow through the oil line is adapted to throttle; and
a gear shift element with which for a non-power transferring gear of the transmission a larger volume through the oil line is adjustable for the non-power transferring gear of the transmission.

2. The transmission control according to claim 1, wherein the transmission is a manual transmission.

3. The transmission control according to claim 1, wherein the oil line comprises a flexible hose and compressible by the throttle element for reducing a flow cross-section.

4. The transmission control according to claim 1, wherein the throttle element comprises a spring-load and with the gear of the oil line engaged, the spring-load is lower than with the gear of the oil line that is not engaged.

5. The transmission control according to claim 1, wherein the throttle element is kinematically guided by the gear shift element via a slotted guide.

6. The transmission control according to claim 1, wherein the throttle element is kinematically guided by the gear shift element via a locking contour.

7. The transmission control according to claim 1, wherein the throttle element is connected to the gear shift element in a purely mechanical manner.

8. The transmission control according to claim 1, wherein the gear shift element is at least part of a locking cylinder adapted to limit a shifting movement of a gearshift rod.

9. The transmission control according to claim 1, wherein the gear shift element is at least part of a locking cylinder adapted to limit a shifting movement of a guiding cylinder.

10. The transmission control according to claim 1, wherein the gear shift element is configured as a protruding gearshift pin, wherein the throttle element is further configured in such a manner that for opening the oil line, the protruding gearshift pin engages with a receiving pocket of the throttle element.

11. The transmission control according to claim 10, wherein the receiving pocket is substantially movable along a circular path.

12. A gear shift mechanism for a transmission of a motor vehicle, comprising:
a manually actuatable gearshift lever;
a gearshift rod connected to the manually actuatable gearshift lever and adapted to move in a direction to shift a gear of the transmission; and
a transmission control connected to the gearshift rod via a gearshift element, the transmission control comprising:
an oil line adapted to lubricate the gear of the transmission assigned to the oil line;
a throttle element with which a volume flow through the oil line is adapted to throttle; and
a gear shift element with which for a non-power transferring gear of the transmission a larger volume through the oil line is adjustable for the non-power transferring gear of the transmission.

13. The gear shift mechanism according to claim 12, wherein the transmission is a manual transmission.

14. The gear shift mechanism according to claim 12, wherein the direction is an axial direction

15. The gear shift mechanism according to claim 12, wherein the direction is a circumferential direction.

16. The gear shift mechanism according to claim 12, wherein the oil line comprises a flexible hose and compressible by the throttle element for reducing a flow cross-section.

17. The gear shift mechanism according to claim 12, wherein the throttle element comprises a spring-load and with the gear of the oil line engaged, the spring-load is lower than with the gear of the oil line that is not engaged.

18. The gear shift mechanism according to claim 12, wherein the throttle element is kinematically guided by the gearshift element via a slotted guide.

19. A method for lubricating a gear of a transmission of a motor vehicle, comprising the steps of:
lubricating the gear with an oil line assigned to the oil line;
throttling an oil volume flow through the oil line with a throttle element; and
adjusting a second oil volume greater than the oil volume flow through the oil line for a non-power transferring gear of the transmission with a gear shift element.

20. The method according to claim 19, in which for each forward transmission gear, in particular each transmission gear, the oil volume flow to an engaged gear of the gear is increased and is reduced to an unengaged gear of the transmission.
